(19) United States
(12) Patent Application Publication
(10) Pub. No.: US 2016/0047753 A1
(43) Pub. Date: Feb. 18, 2016

(54) METHOD AND DEVICE FOR TESTING A TIRE

(71) Applicant: Steinbichler Optotechnik GmbH, Neubeuern (DE)

(72) Inventor: Rainer HUBER, Piding (DE)

(21) Appl. No.: 14/826,048

(22) Filed: Aug. 13, 2015

(30) Foreign Application Priority Data
Aug. 13, 2014 (DE) 10 2014 012 095.3

(51) Int. Cl. G01N 21/95; G01N 21/59; G01N 21/55

(52) U.S. Cl. CPC G01N 21/95; G01N 21/55; G01N 21/59; G01N 2021/1742

(57) ABSTRACT

In an improved method for testing a tire, the tire is irradiated with electromagnetic radiation in the THz frequency range. The radiation reflected by the tire is received and evaluated.

### CROSS REFERENCE TO RELATED APPLICATION

This application claims priority to German Patent Application No. 10 2014 012 095.3, entitled “Method and Device for Testing a Tire,” filed Aug. 13, 2014, the contents of which is hereby incorporated by reference in its entirety for all purposes.

### TECHNICAL FIELD

The present disclosure relates to a method for testing a tire and to a device for carrying out this method.

### BACKGROUND AND SUMMARY

Tires for vehicles of all types are constructed from different components. In general, the tire consists of a carcass and a tread. Wires or threads form the bearing structure of the carcass. They are embedded in layers made of different types of rubber having different mechanical properties. A metal mesh, as “belt,” can stabilize the tread. In the tread, different layers are provided, in order to ensure the desired running characteristics, the desired resistance to abrasion, the desired electrical conductivity and the desired lowest possible rolling resistance.

In the tire manufacturing process, blanks made of the individual components are pressed at high pressures and temperatures into a specific tire mold. Here, the individual components have to vulcanize completely at the correct sites in the finished tire. In order to be able to verify this, individual tires can be tested by destruction by way of a random sample. A non-destructive tire testing is also possible, particularly using X-ray apparatuses and computed tomography apparatuses. However, these apparatuses are expensive. Moreover, they produce only limited results, because various types of rubber can be distinguished by them only barely or not at all.

On the basis of this, the present disclosure is based on the issue of providing a cost-effective non-destructive method for testing a tire as well as an associated device.

In one example, the above may be addressed by a method wherein the tire is irradiated with electromagnetic radiation in the THz (terahertz) frequency range. The radiation passing through the tire and/or the radiation reflected by the tire is received and evaluated. Here, in the sense of the present disclosure, a tire is understood to mean both a finished tire as well as a non-vulcanized tire.

By the present disclosure, a rapidly carried out, cost-effective and non-destructive test method for tires is created. As a result, the development of tires can be simplified. In the manufacturing process, a consistent high product quality can be ensured.

In further examples, the method may include various advantageous refinements.

The frequency of the radiation may be, for example, between 0.1 to 2.0 THz, between 0.2 to 1.5 THz, between 0.2 to 1.2 THz, between 0.2 to 0.8 THz, or 0.3 THz.

The tire can be irradiated with electromagnetic radiation in the form of a radiation pulse. A plurality of frequencies or any frequencies can be contained in this radiation pulse.

Additionally, or alternatively, the tire can be irradiated with electromagnetic radiation in wave form. Advantageously, the tire may be irradiated with electromagnetic radiation in the form of a sinusoidal wave.

In one example, the amplitude and/or the travel time of the radiation that has passed through the tire and/or has been reflected by the tire is evaluated.

Additionally, or alternatively, the spectrum of the radiation that has passed through the tire and/or that has been reflected by the tire can be evaluated.

An additional example advantageous refinement is characterized in that one of more of the refractive index, the absorption coefficient, the thickness, the material type, the overlapping of the tire of one or more layers or of all the layers of the tire may be determined.

According to another example advantageous refinement, the position of a conductive layer in the tire is determined. Here, it is possible to determine, in particular, whether a conductive strip is located on the surface of the tire and/or on the surface of one or more layers or of all the layers of the tire. Furthermore, it can be determined, in particular, whether the conductive strip is covered from one side and/or from both sides by a rubber layer, in particular by rubber layers made of the same material.

In a further example, the radial runout and/or the circumference of the tire is/are determined. The radial runout here is understood to mean a deviation of the radius or diameter of the tire as a function of the circumference of the tire.

Another example advantageous refinement includes the determination of the position and/or the separation distance of one or more threads and/or wires from one another and/or from one surface or both surfaces of the tire and/or from one or more layers or from all the layers of the tire.

According to another example advantageous refinement, the flaws in the tire and/or in one or more layers or in all the layers of the tire are determined. Flaws can be, in particular, foreign bodies and/or air inclusions and/or air bubbles.

The tire can be irradiated from one side. However, it is also possible to irradiate the tire from two mutually opposite sides.

According to another example advantageous refinement, the radiation that has passed through the tire and/or that has been reflected by the tire is received by one or more sensors. The multiple sensors arranged in a planar array.

In a further example, the position of the radiation relative to the tire can be changed. For this purpose, the tire can be movable relative to the radiation source. Instead or in addition, the radiation source can also be movable relative to the tire. Rotary axles, axle systems and/or robots are particularly suitable as moving devices.

Another advantageous example refinement includes producing, in the evaluation of the radiation, a 2D representation and/or a 3D representation of the tire and/or of one or more layers or of all the layers of the tire. The 2D representation and/or the 3D representation can be stored and/or evaluated and/or processed further.

In another example, a device for providing a cost-effective non-destructive method for testing a tire includes a radiation source for emitting electromagnetic radiation in the THz frequency range; a receiving device for receiving the radiation that has passed through a tire and/or the radiation that has been reflected by the tire; and an evaluation device for evaluating the radiation received at the receiving device. The device according to the present disclosure for carrying out the method according to the present disclosure comprises a radiation source for electromagnetic radiation in the THz frequency range, a receiving device for receiving the radiation that has passed through the tire and/or the radiation that has been reflected by the tire, and an evaluation device for evaluating the received radiation. The evaluation device can be formed by a controller including computer-readable instructions stored on non-transitory memory for performing the method described herein based on input from various sensors and by sending signals to various actuators. In one example, the control system includes a computer, such as a personal computer (PC).

According to another example advantageous refinement, the receiving device comprises one or more sensors. The multiple sensors are preferably arranged in a linear or planar array.

It is advantageous if the device comprises a moving device for moving the tire and/or the radiation source relative to one another, in particular a rotary axle, an axle system and/or a robot.

It is advantageous if the device comprises another device according to the present disclosure which is arranged on the opposite side of the tire.

Example embodiments of the present disclosure are explained in detail below in reference to the appended drawings.

### BRIEF DESCRIPTION OF THE FIGURES

FIG. 1 shows an example embodiment of a device for testing a tire with a radiation source for electromagnetic radiation in the THz frequency range and a receiving device for receiving the radiation reflected by a tire in a diagrammatic side view in partial section.

FIG. 2 shows an example variant of the embodiment according to FIG. 1, in which the radiation source and the receiving device are arranged inside the tire.

FIG. 3 shows another example variant of the device according to FIGS. 1 and 2, in which the two devices, each with a radiation source and each with a receiving device, are arranged on opposite sides of the tire.

FIG. 4 shows a diagrammatic view of the device according to FIG. 2 as well as of the associated pulse curve.

FIG. 5 shows another diagrammatic view as in FIG. 4 with another tire.

FIG. 6 shows a diagrammatic representation of a device for testing a tire with a radiation source for electromagnetic radiation in the THz frequency range and with a receiving device for receiving the radiation that has passed through a tire, but without tire, in a diagrammatic side view, and the associated pulse curve.

FIG. 7 shows the device represented in FIG. 6 and an associated pulse curve.

FIG. 8 shows a representation corresponding to FIG. 1, in which there is a flaw in the tire.

FIG. 9 shows another construction of a tire in a sectional representation.

FIG. 10 shows a sectional representation through a tire with overlapping layers.

FIG. 11 shows a device for testing a tire with a receiving device, which comprises several sensors which are arranged in a planar array, in a perspective representation.

FIG. 12 shows a section through a tire in a perspective representation.

FIG. 13 shows a variant of the device represented in FIG. 1 with a semitransparent mirror.

### DETAILED DESCRIPTION

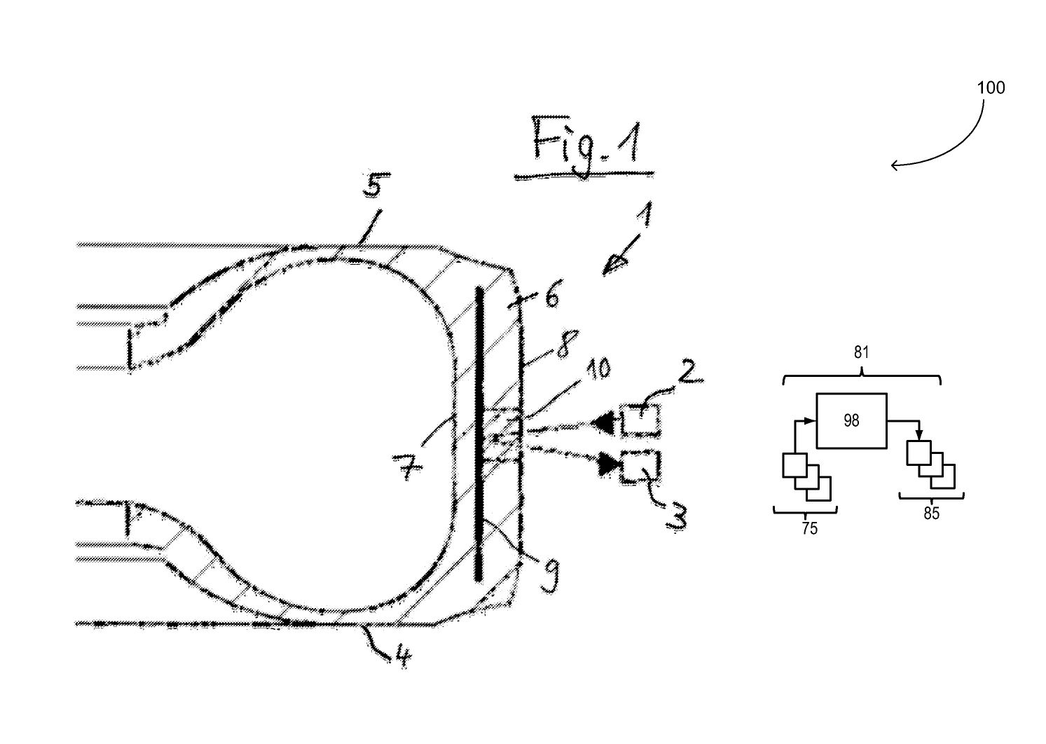

FIG. 1 shows a device 100 for testing a tire 1, which comprises a radiation source 2 for electromagnetic radiation in the THz frequency range and a receiving device 3 for receiving the radiation reflected by the tire 1. The device comprises, furthermore, an evaluation device for evaluating the radiation received by the receiving device 3 (not represented in the drawing). Device includes a control system 81 having various modules and/or interfaces that include control routines stored in the memory of the electronic control system 81. The electronic system 81 may be communicatively coupled with sensors 75 (such as receiving device 3), actuators 85, and/or displays for receiving data including input information, sensor information, and for sending actuator control and/or display information. The electronic control system may include a processor and memory 98, in combination with sensors and actuators, to carry out the various controls described herein. In one example, the evaluation device is included as a module in control system 81. Further, the control system may include a display for displaying data regarding the tire generated by the evaluation device. For example, the radiation pulses described below may be displayed on the display. As another example, the display may be used to indicate that a tire is flawed or not flawed (e.g., when a flawed tire is identified, a flawed tire flag may be displayed and/or transmitted to another device, and when a non-flawed tire is identified, a pass flag may be displayed and/or transmitted to the other device, the pass flag being different from the flawed tire flag). Further, the display may be changed based on the nature or type of flaw identified.

The tire comprises a lower side surface 4, an upper side surface 5, and a tread 6, which is delimited by an inner tire tread area 7 and an outer tire tread area 8. Several layers can be present within the tread 6. An electrically conductive layer 9 is located in the center of the tread 6. This electrically conductive layer 9 is the metallic belt of the tire 1. It represents a reflector for THz radiation. Furthermore, in the tread 6, a central ridge 10 consisting of a rubber with high electrical conductivity is located. The central ridge 10 is intended to reduce electrostatic charging of the tire. It is arranged between the electrically conductive layer 9 and the outer tire tread area 8. The central ridge 10 connects the outer tire tread area 8 to the electrically conductive layer 9. It extends over only a portion of the height of the tire 1.

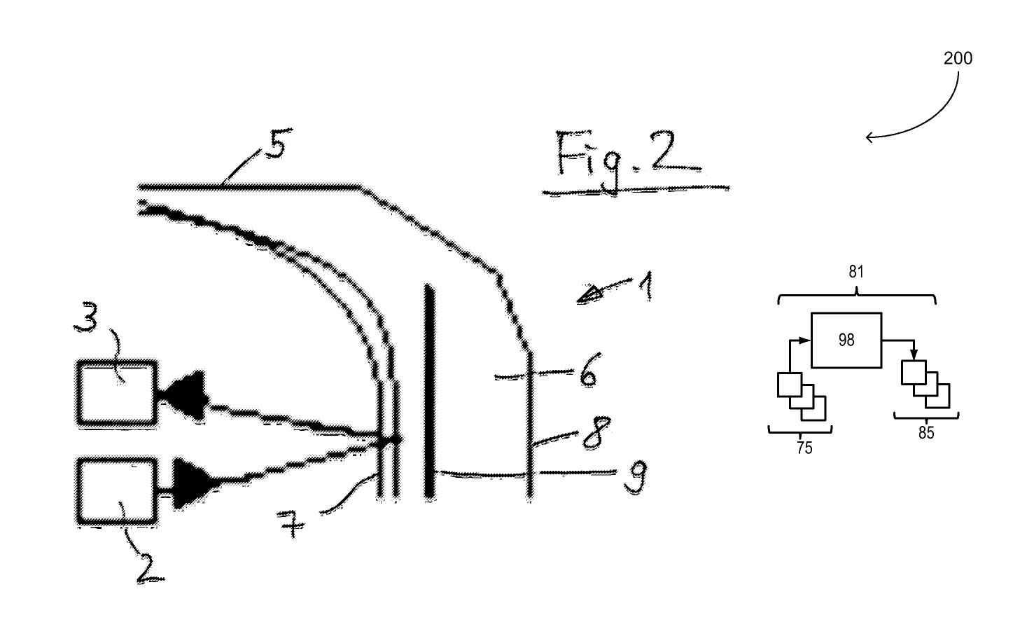

In an alternate embodiment 200, depicted at FIG. 2, the radiation source 2 and the receiving device 3 are arranged not on the outer side of the tire 1 but rather inside the tire 1.

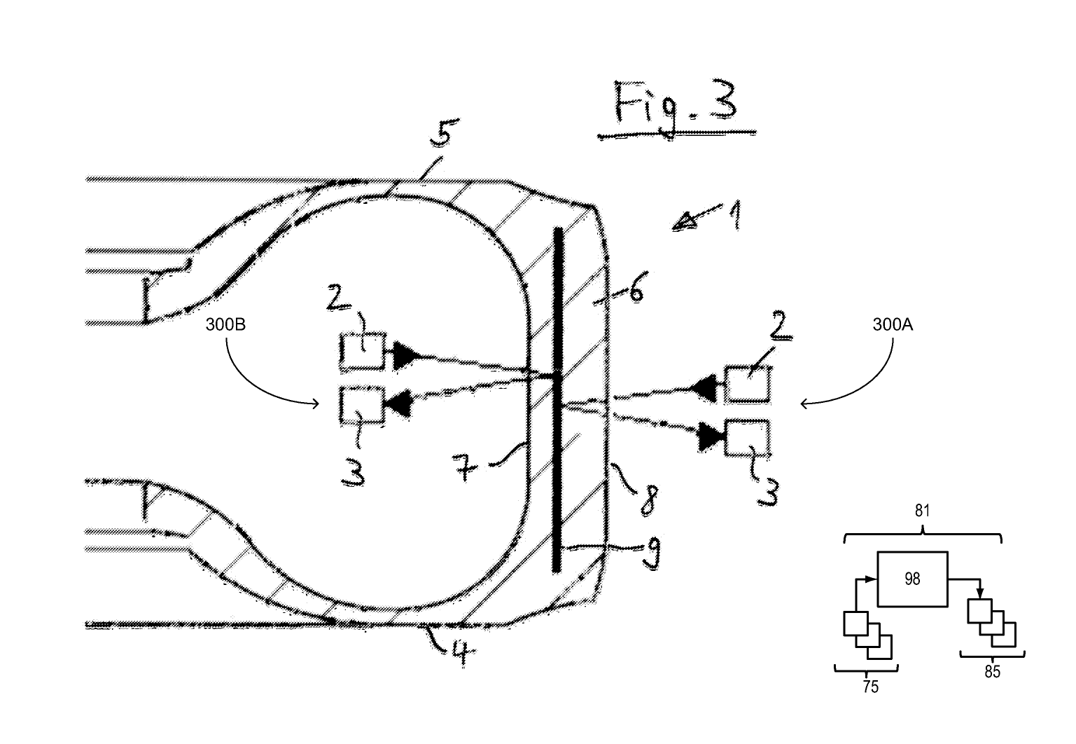

In the example embodiment according to FIG. 3, aspects of the two embodiments according to FIGS. 1 and 2 are combined. Herein, devices 300A and 300B are provided for testing the tire, each of which comprises a radiation source 2 and a receiving device 3, are located on opposite sides of the tread 6 of the tire 1. One of these devices 300A is arranged on the outside of the tire 1 and the other device 300B is arranged inside the tire 1. The devices are located on both sides of the tread 6.

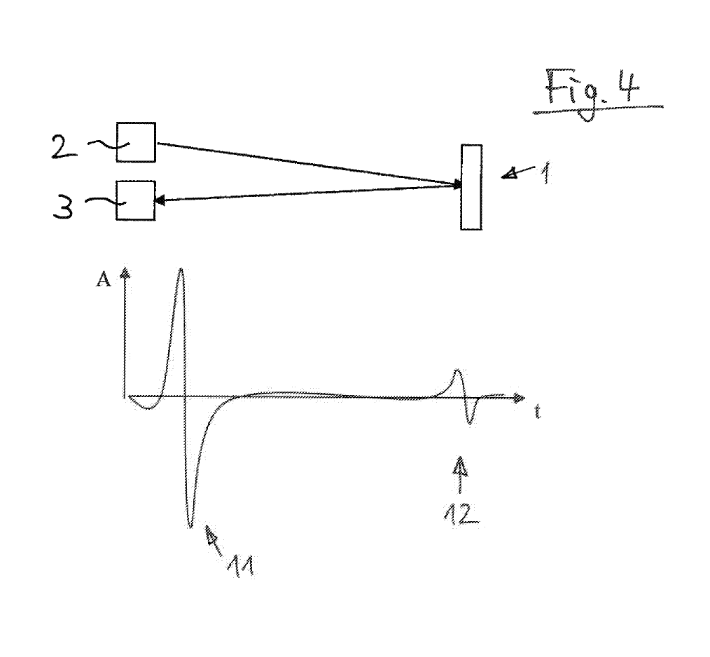

The embodiments according to FIGS. 1, 2 and 3 each work with incident light. Here, the radiation source 2 and the receiving device 3 are each located on the same side of the tire 1. The associated pulse curve is represented in FIG. 4. Electromagnetic radiation in the THz frequency range is emitted in the form of a radiation pulse 11 by the radiation source 2. The lower portion of FIG. 4 shows the curve of the amplitude A of the electromagnetic radiation over time t. The radiation pulse 11 emitted consists of a small negative amplitude, a subsequent brief high positive amplitude, a subsequent brief high negative amplitude, and decay to the zero line.

In the right portion of FIG. 4, the associated radiation pulse 12 is represented, which is received by the receiving device 3, after the radiation originating from the radiation source 2 has been reflected by the tire 1 and has been received by the receiving device 3. As is apparent from FIG. 4, the signal at the receiving device 3 is temporally delayed and has a weaker amplitude A. From the amplitude of the associated radiation pulse 12 and/or the amplitude ratio between received radiation and emitted radiation (that is, radiation pulse 11 and radiation pulse 12), and/or from the travel time and/or from the phase and/or from the phase difference of pulses 11, 12, it is possible to reach a conclusion as to the properties of the tire 1 and/or of one or more layers or of all the layers of the tire 1.

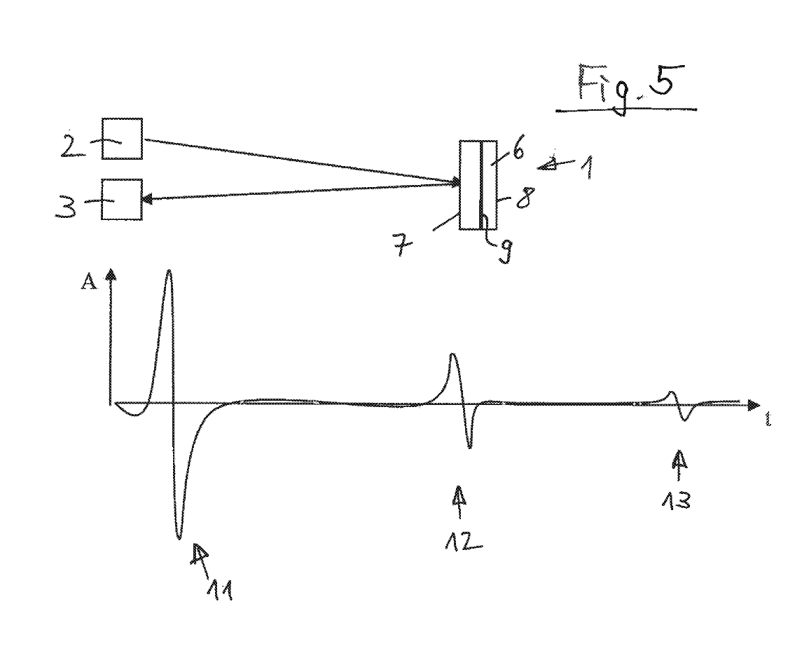

FIG. 5 shows an arrangement corresponding to FIG. 4, with another tire 1. Here, a tire 1 with a layer construction as in the tire 1 represented in FIGS. 1, 2 and 3 is tested. This layer construction is associated with the amplitude curve shown in the lower portion of FIG. 5. Here too, a radiation pulse 11 is emitted. A first radiation pulse 12 and a second radiation pulse 13 are received by the receiving device 3. From these radiation pulses 12, 13, in particular from the amplitude curves, the amplitude ratios, the durations, the phases and/or the phase differences, it is possible to draw conclusions regarding the properties of the tire 1 and/or of one or more layers or of all the layers of the tire 1.

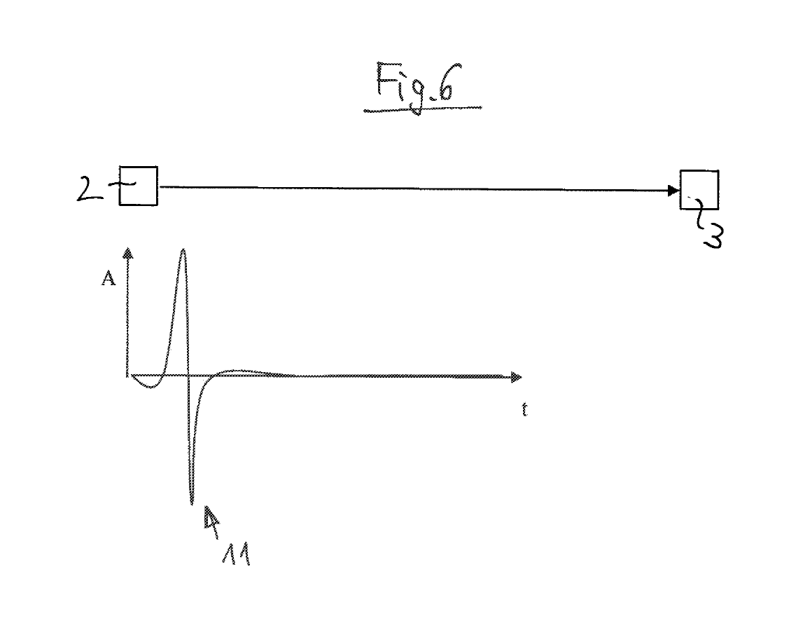

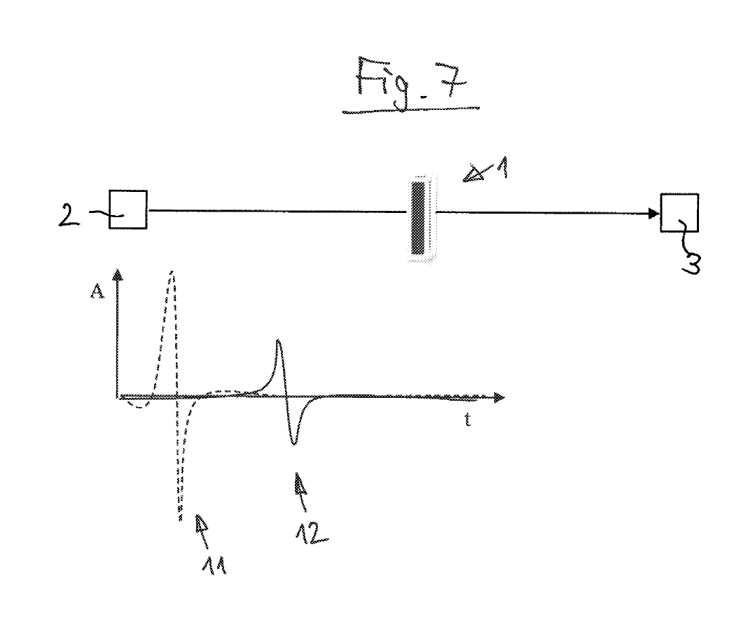

FIGS. 6 and 7 show an embodiment that works with transmitted light, that is to say in which the radiation source 2 and the receiving device 3 are located on different sides of the tire and in which the receiving device 3 receives the radiation passing through the tire 1. In the representation of FIG. 6, there is no tire. The radiation pulse 11 originating from the radiation source 2 thus generates the same radiation pulse 11 in the receiving device 3, and in fact, practically without any temporal delay.

In the representation of FIG. 7, the tire 1 (such as tire 1 of FIGS. 1, 2, and 3) is located between the radiation source 2 and the receiving device 3. Here, the radiation pulse 11 which originates from the radiation source 2 generates the radiation pulse 12 in the receiving device 3. The received radiation pulse 12 is evaluated.

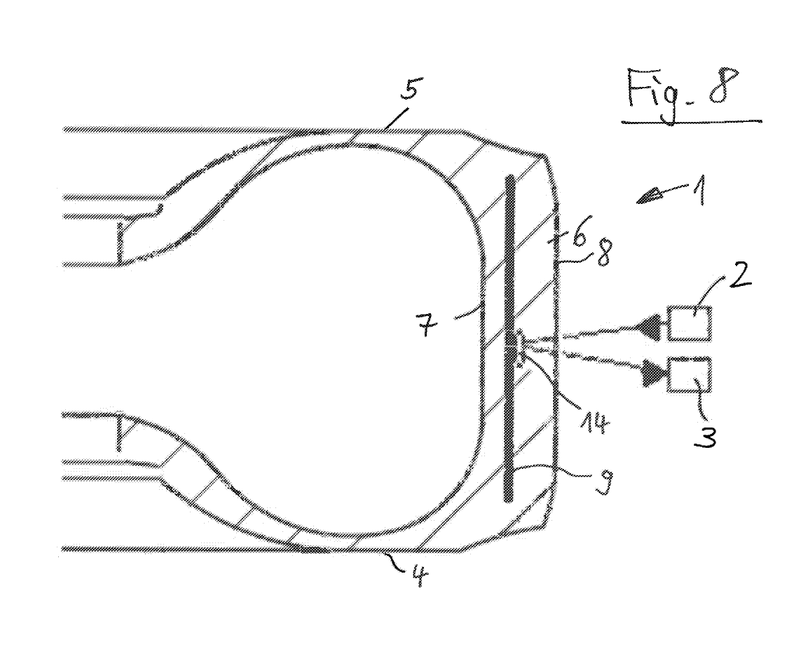

FIG. 8 shows the device represented in FIG. 1. Here, in the tread 6 of the tire 1, there is a flaw 14 which can be detected by the device. The flaw 14 is an air inclusion.

In one example, radiation pulses 11, 12 and/or 13 may be displayed to a user (e.g., operator or service technician) on a display of the device's control system. Based on the radiation pulse, the control system may further display one or more tire characteristics. For example, the control system may display that the tire is flawed or not flawed. Further, the display may be varied based on the presence of a flaw, and a type of the flaw. For example, if a flaw is identified, a message indicating that the tire is flawed and should be discarded may be displayed. As another example, the control system may display tread characteristics of the tire as determined based on the radiation pulses.

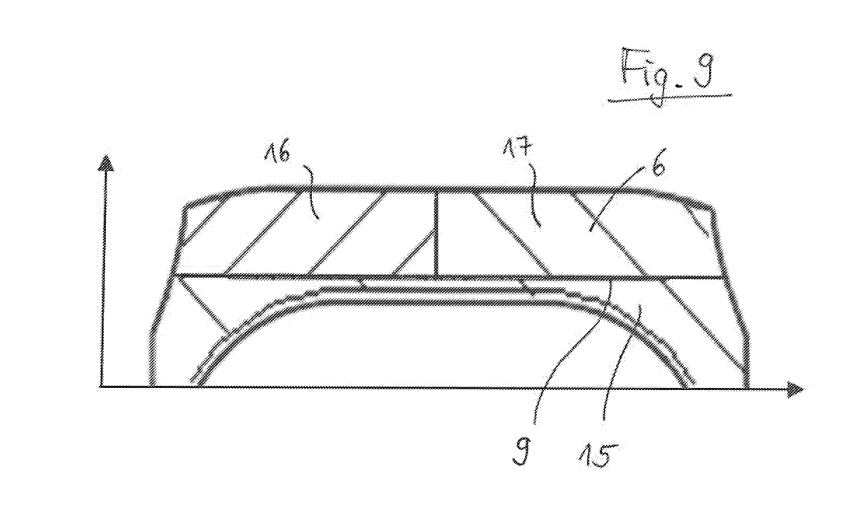

FIG. 9 shows a cross section through a tire, in which the tread 6 has an inner continuous area 15, a first outer area 16, and a second outer area 17. The inner area 15 and the outer areas 16, 17 are separated from one another by a conductive layer 9.

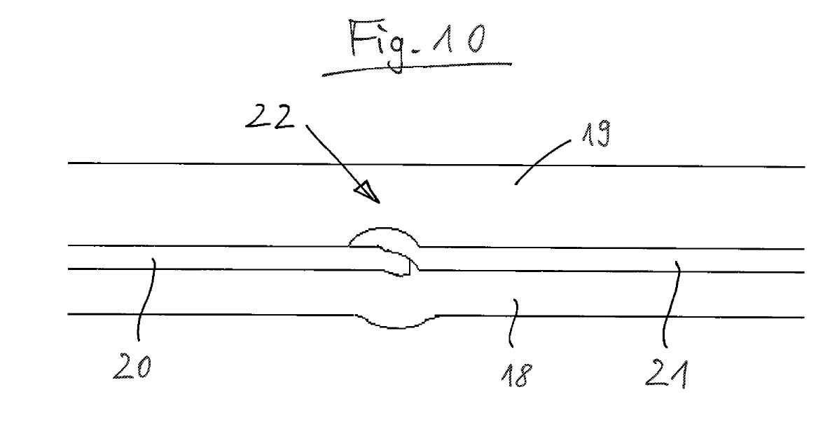

Represented in FIG. 10 is a longitudinal section through a tire with an inner continuous layer 18 and an outer continuous layer 19. A first central layer 20 and a second central layer 21, which are connected to one another in an overlap area 22, are located between these layers 18, 19. Properties and/or sizes of the overlap area 22 can be determined by the device according to the present disclosure.

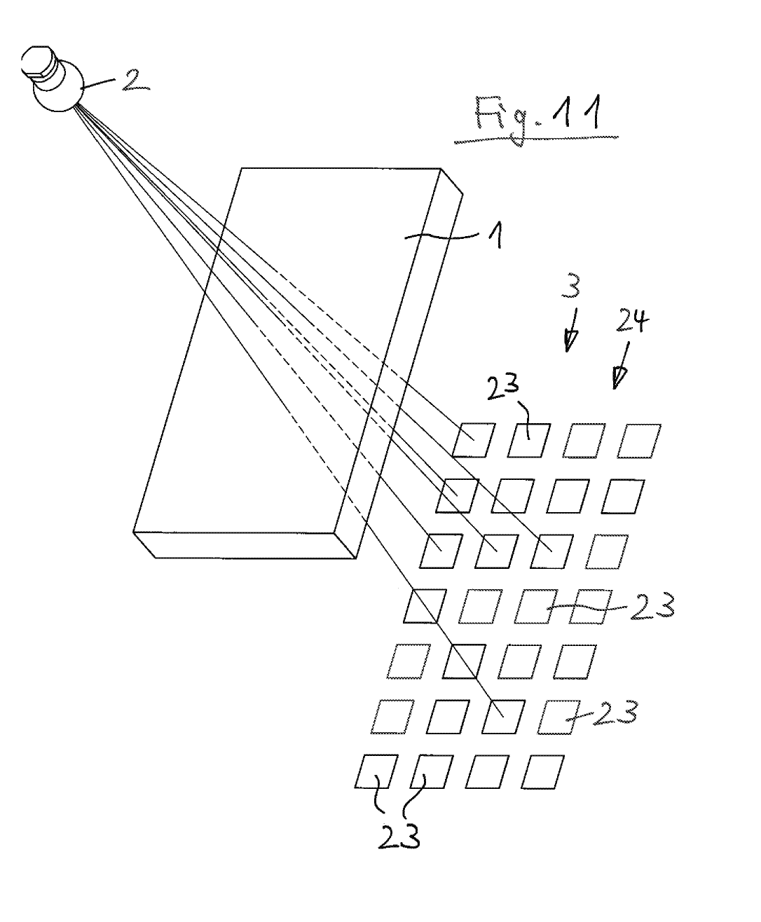

FIG. 11 shows a portion of an embodiment with a radiation source 2 for electromagnetic radiation in the THz frequency range and a receiving device 3 comprising multiple sensors 23. This pertains to a multitude of sensors 23 which are arranged in a planar array 24. A portion of the tire 1 is located between the radiation source and the array 24. The device according to FIG. 4 works with transmitted light.

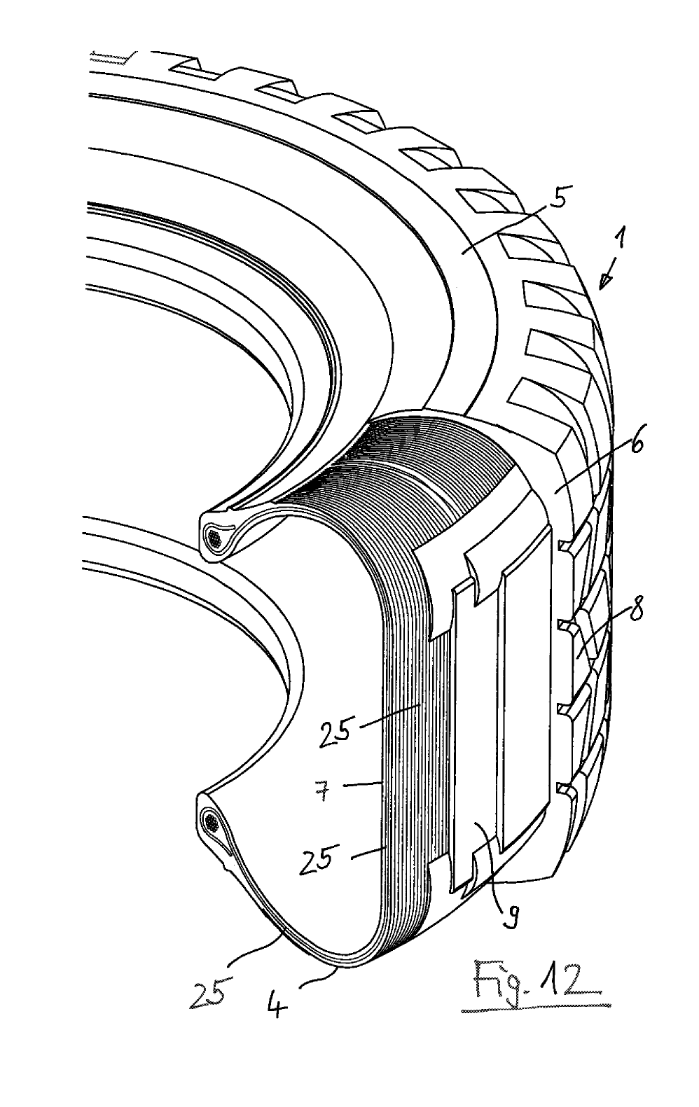

FIG. 12 shows a section through a tire 1 in a perspective representation. In the tread 6, carcass threads 25 are located, which extend in the radial direction. The carcass threads 25 extend parallel to one another and at a distance from one another. They can be determined by the method according to the present disclosure. In particular, it is possible to determine the separation distance of the carcass threads 25 from one another and/or from the inner tire tread area 7 and/or from the outer tire tread area 8 by irradiating the tire with electromagnetic radiation in the THz frequency range, and receiving and evaluating radiation that has passed through the tire and/or radiation that has been reflected by the tire.

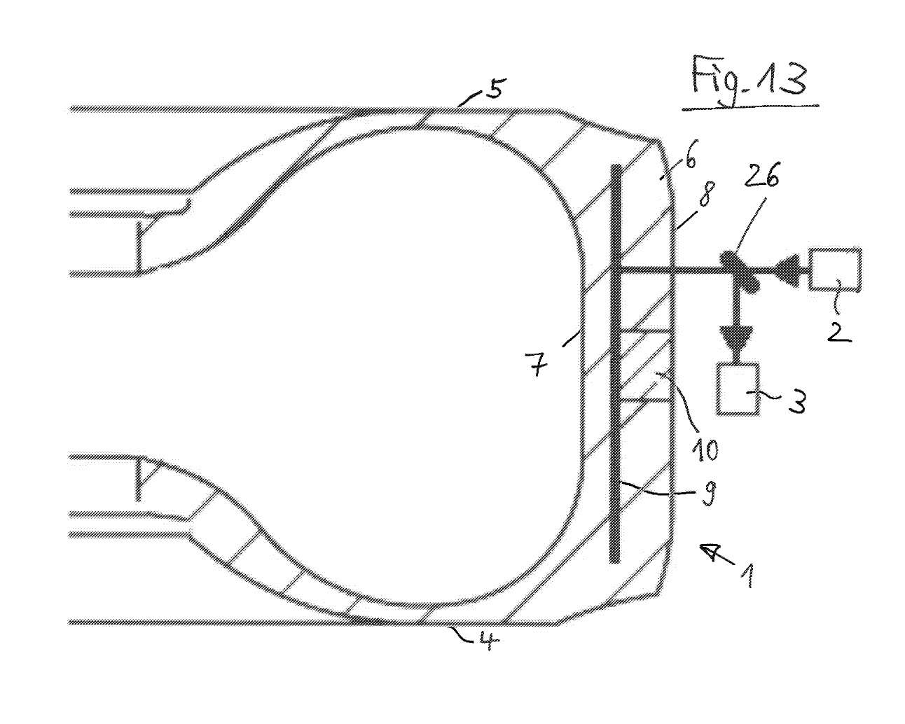

FIG. 13 shows a variant of the device represented in FIG. 1, in which corresponding components are provided with the same reference numerals and are not described again. Here, a semitransparent mirror 26 is arranged in the beam path from the radiation source 2 to the tire 1. A portion of the THz radiation originating from the radiation source 2 is radiated onto the tire 1. The radiation reflected by the tire 1 is partially reflected by the semitransparent mirror 26 towards the receiving device 3 and received there.

By means of the present disclosure, it is possible to detect in the tire, in particular in its tread and/or in the rest of its tire structure, different components, in particular different types of rubber. It is also possible to measure and/or graphically represent their position and/or thickness. The same applies to metallic components of the tire. A geometric measuring of the tire and its components is also possible, in particular of the radial runout, the thickness, the circumference and/or of a layer overlapping of a tire and/or individual layers of the tire. It is possible to determine and evaluate the separation distance of individual threads and/or wires located in the tire, and, in particular, both the separation distance of the threads and/or wires from one another and also the separation distance of the threads and/or wires from the tire surface. Furthermore, the present disclosure allows an automatic evaluation of the results found.

The present disclosure also allows an identification of different components in tires, in particular rubber tires, with a THz spectrometer in reflection arrangement and/or with transmitted light, on the basis of their different optical properties, in particular based on the optical density and absorption. As a result of these different optical properties, signals that are typical for the materials arise at the receiver of the THz spectrometer, which can be used for the determination of the material. If a tire contains one or more metal layers that are “nontransparent” to the THz rays, a separate investigation of the tire construction from the two sides of the metal, that is to say from different sides of the tire, may be performed. In the tire, the existence of different materials can also be detected, and their position and density can be measured.

The testing of the tire can be carried out with the tire lying down; however, it can also be done with the tire standing or suspended. Here, the entire tire surface to be tested is accessible for simultaneous testing.

The tire can be examined with a point sensor. However, it is also possible to use a plurality of sensors that are arranged in a linear or planar array. The sensor(s) can be moved along the tire with a special axle system or with a robot, in order to measure the entire tire. Instead or in addition, the tire can also be moved. In particular, it can be rotated about its running axle.

The measurements can be carried out both with a THz pulse and also with a wave, such as a sinusoidal wave, as excitation. In pulse systems we speak of time domain spectrometers; in wave systems, we speak of frequency domain spectrometers. There are apparatuses that detect both the amplitude and also the travel time of the signal, as well as apparatuses that can only determine the amplitude. The last-mentioned apparatuses are more cost effective, but they cannot be used for layer thickness measurement, in particular; instead they merely indicate whether certain materials are present.

For the spectral analysis, the travel time and the amplitude damping relative to a reference signal can be determined and evaluated. In the case of transmitted light arrangements, the reference signal can be formed by a pulse that has traveled only through air and not through a tire. In incident light arrangements, the reference signal can be formed by a reflection from an ideal reflector, for example, from a metal plate.

By Fourier transformation, the measured time signal can be converted to the frequency domain. The amplitude is recovered in the frequency domain in the form of a frequency-dependent amplitude that is in the form of an amplitude spectrum, and the travel time is recovered in the form of a frequency-dependent phase, that is in the form of a phase spectrum. For the spectral analysis, the so-called transfer function can be determined, that is to say the quotient of the sample spectrum divided by the reference spectrum. From the transfer function, the frequency-dependent refractive index and the absorption coefficient of the sample can be determined. Both parameters are characteristic material variables for the rubber samples. The refractive index here is a proxy for the optical density or the time delay that the sample caused, and the absorption coefficient is a proxy for the damping properties. If the refractive index and the absorption coefficient are known, one sample measurement is sufficient for the layer thickness determination.

No characteristic material data are needed to determine whether a conductive strip is located on the surface or covered by a rubber layer. Electrical layers, like metals, are good reflectors. If, in the signal, in addition to the reflection from the surface, a second reflection exists, then it may be indicated that the conductive layer is covered by a rubber layer. If the thickness of the latter rubber layer also needs to be determined, then the material parameters also need to be known.

In tread analysis, it is possible to determine, without knowing the material data, whether one side of the tire is made of a harder rubber and the other side of the tire is made of a softer rubber. A harder rubber has a greater refractive index. The reflection from this side has a higher amplitude than the reflection from the softer side. For an exact identification of the rubber type on the basis of the material parameters one again needs a reference measurement and sample measurement.

1. A method for testing a tire, comprising: irradiating the tire with electromagnetic radiation in the THz frequency range, and receiving and evaluating radiation that has passed through the tire and/or radiation that has been reflected by the tire.

2. The method according to claim 1, wherein the frequency of the radiation is one of between 0.1 to 2.0 THz, between 0.2 to 1.5 THz, between 0.2 to 1.2 THz, between 0.2 to 0.8 THz, and 0.3 THz.

3. The method according to claim 1, wherein the tire is irradiated with electromagnetic radiation in the form of a radiation pulse.

4. The method according to claim 1, wherein the tire is irradiated with electromagnetic radiation in wave form, the electromagnetic radiation including a sinusoidal wave.

5. The method according to claim 1, wherein one or more of an amplitude and a travel time of the radiation is evaluated.

6. The method according to claim 1, wherein a spectrum of the radiation is evaluated.

7. The method according to claim 1, wherein the evaluating further includes determining one or more of a refractive index, an absorption coefficient, a thickness, a material type and an overlapping for one or more of the tire, one or more layers of the tire, and all of the layers of the tire.

8. The method according to claim 1, wherein the evaluating further includes determining a position of a conductive layer in the tire.

9. The method according to claim 1, wherein the evaluating further includes determining one or more of a radial runout and a circumference of the tire.

10. The method according to claim 1, wherein the evaluating further includes determining one or more of a position and a separation distance of one or more threads and/or wires from one another, from one surface or both surfaces of the tire, from one or more layers, and from all the layers of the tire.

11. The method according to claim 1, wherein the evaluating further includes determining flaws in one or more of the tire, one or more layers of the tire, and in all the layers of the tire.

12. The method according to claim 1, wherein irradiating the tire includes irradiating the tire from one side of the tire or from two mutually opposite sides of the tire.

13. The method according to claim 1, wherein the radiation is received by one or more sensors arranged in a planar array.

14. The method according to claim 1, further comprising, changing a position of the radiation relative to the tire.

15. The method according to claim 1, wherein the evaluating includes producing one of a 2D representation and a 3D representation of the tire, one or more layers of the tire, or of all the layers of the tire.

16. A system, comprising:
a device including:
a radiation source for emitting electromagnetic radiation through a tire in the THz frequency range;
a receiving device for receiving one of the radiation that has passed through the tire and the radiation that has been reflected by the tire; and
an evaluation device with computer readable instructions stored on non-transitory memory for evaluating the radiation received at the receiving device.

17. The system according to claim 16, wherein the receiving device comprises one or more sensors arranged in a linear or a planar array.

18. The system according to claim 16, further comprising a moving device for moving one or more of the tire and the radiation source relative to one another.

19. The system according to claim 16, wherein the device is a first device arranged on a first side of the tire, the system further comprising a second device arranged on an opposite side of the tire, the second device identical to the first device.

20. A method, comprising:
irradiating a tire with electromagnetic radiation in the THz frequency range from a radiation source;
receiving, at a receiving device, each of radiation that has passed through the tire and radiation reflected by the tire;
evaluating, at an evaluation device, the radiation received at the receiving device; and
estimating one or more tire attributes based on the evaluating.
